(19) United States
(12) Patent Application Publication
(10) Pub. No.: US 2022/0379337 A1
(43) Pub. Date: Dec. 1, 2022

(54) COATING DEVICE, COATING FILM, AND COATING METHOD

(71) Applicant: KYOCERA CORPORATION, Kyoto-shi, Kyoto (JP)

(72) Inventors: Daisuke HOZUMI, Kirishima-shi, Kagoshima (JP); Ayumu MATSUMOTO, Kirishima-shi, Kagoshima (JP)

(21) Appl. No.: 17/638,855

(22) PCT Filed: Jul. 31, 2020
(86) PCT No.: PCT/JP2020/029571

§ 371 Date: Jul. 24, 2022

(30) Foreign Application Priority Data
Aug. 30, 2019 (JP) 2019-159140

(51) Int. Cl. B05C 5/02; B05C 11/00

(52) U.S. Cl. CPC B05C 5/0208; B05C 11/00

(57) ABSTRACT

A coating device coats a coating region of a to-be-coated object having a convex curved surface. A coating device includes a head, an arm, and a controller. The head includes a nozzle surface. The arm holds the head. The controller controls movement of the head via the arm. A controller moves a head in a first direction along an end portion of a coating region in a posture in which a gap between a nozzle surface located on an end portion side of the coating region and a to-be-coated object is smaller than a gap between the nozzle surface located on a center side of the coating region and the to-be-coated object.

### TECHNICAL FIELD

Disclosed embodiments relate to a coating device, a coating film, and a coating method.

### BACKGROUND ART

A coating device using an inkjet method is known. A head for discharging a coating material is mounted on such a coating device of an inkjet method.

### CITATION LIST

### Patent Literature

Patent Document 1: JP 06-121944 A
Patent Document 2: JP 07-108212 A

### SUMMARY

A coating device according to an aspect of an embodiment coats a coating region of a to-be-coated object having a convex curved surface. A coating device includes a head, an arm, and a controller. The head includes a nozzle surface. The arm holds the head. The controller controls movement of the head via the arm. The controller moves the head in a first direction along an end portion of the coating region in a posture in which a gap between the nozzle surface located on the end portion side of the coating region and the to-be-coated object is smaller than a gap between the nozzle surface located on a center side of the coating region and the to-be-coated object.

### BRIEF DESCRIPTION OF DRAWINGS

FIG. 1 is an explanatory view of a coating device according to an embodiment.

FIG. 2 is a cross-sectional view illustrating an example of a to-be-coated object that was coated.

FIG. 3 is an explanatory view illustrating an example of an arrangement of a head included in a coating device according to a first embodiment.

FIG. 4 is an explanatory view illustrating an example of discharge drops discharged from a coating device according to a second embodiment.

FIG. 5A is an explanatory view comparing discharging techniques of a coating material.

FIG. 5B is an explanatory view comparing discharging techniques of a coating material.

FIG. 6 is an explanatory view illustrating an example of discharge drops discharged from a coating device according to a third embodiment.

FIG. 7 is a partial enlarged view of FIG. 6.

FIG. 8 is an explanatory view illustrating an example of discharge drops discharged from a coating device according to a fourth embodiment.

FIG. 9 is a cross-sectional view illustrating an example of a coated body according to an embodiment.

FIG. 10 is a view illustrating an example of a head according to a variation of the embodiments.

### DESCRIPTION OF EMBODIMENTS

Embodiments of a coating device, a coating film, and a coating method disclosed in the present application will be described in detail below with reference to the accompanying drawings. Note that the present invention is not limited to the embodiments that will be described below.

### Configuration of Coating Device

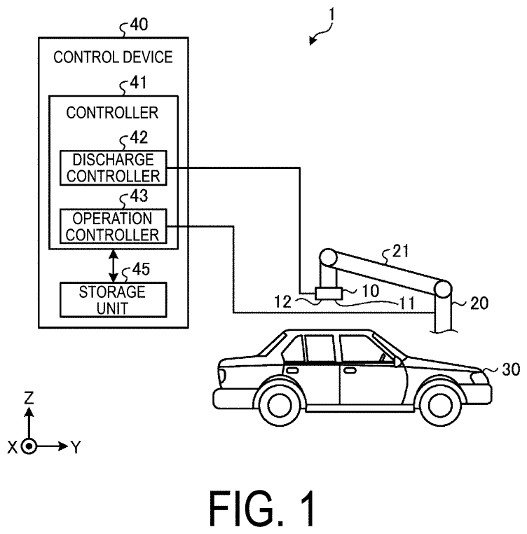

First, with reference to FIG. 1, a description will be given of an overview of a coating device according to an embodiment. FIG. 1 is an explanatory view of the coating device according to the embodiment. For the sake of clarity, FIG. 1 illustrates a three dimensional orthogonal coordinate system including a Z-axis including a vertically upward direction serving as a positive direction and a vertically downward direction serving as a negative direction. Such an orthogonal coordinate system may also be illustrated in other drawings used in the description below. The same components as those of the coating device 1 illustrated in FIG. 1 are denoted by the same reference numerals, and descriptions thereof will be omitted or simplified.

As illustrated in FIG. 1, a coating device 1 includes a head 10, a robot 20, and a control device 40.

The head 10 is fixed to the robot 20. The head 10 moves in response to movement of the robot 20 controlled by the control device 40. The head 10 can use, for example, an inkjet head of a valve type, a piezo type, or a thermal type. When a piezo type or thermal type inkjet head is used as the head 10, high resolution is easily realized.

The head 10 coats a to-be-coated object 30 by depositing a coating material discharged from a plurality of discharge holes 11 located on a nozzle surface 12 onto a surface of the to-be-coated object 30 facing the nozzle surface 12.

The coating material is supplied to the head 10 from a tank (not illustrated). The head 10 discharges the coating material supplied from the tank. The coating material is a mixture containing a volatile component and a nonvolatile component, and has fluidity. Note that the tank may be a reservoir (not illustrated) housed in the head 10.

The volatile component is, for example, water, organic solvent, or alcohol, and adjusts the physical properties such as viscosity and surface tension of the coating material. The nonvolatile component contains, for example, a pigment, a resin material, and an additive. The pigment includes one or more colored pigments used depending on a desired coating color. The resin material is deposited on the to-be-coated object 30 and forms a film. The additive is a functional material that is added, for example for purposes of weather resistance and the like.

Note that the coating material supplied to the discharge holes 11 is prepared such that a desired coating color is expressed by mixing a plurality of colored pigments or coating materials at predetermined proportions.

The robot 20 holds the head 10. The robot 20 is, for example, a six-axis articulated robot. The robot 20 may be, for example, a vertical articulated robot or a horizontal articulated robot. The robot 20 includes a plurality of arms 21 with the head 10 fixed to a tip of the plurality of arms 21. The robot 20 is fixed to a floor, a wall, a ceiling, or the like. Note that as long as the held head 10 can be moved properly, there is no limit to the degree of freedom of the arms 21 included in the robot 20.

The control device 40 controls the coating device 1. The control device 40 includes a controller 41 configured to control the coating device 1, and a storage unit 45. The controller 41 includes a discharge controller 42 and an operation controller 43.

The controller 41 includes a computer or various circuits including, for example, a central processing unit (CPU), a read only memory (ROM), a random access memory (RAM), a hard desk drive (HDD), and an input/output port. The CPU of such a computer functions as the controller 41 by, for example, reading and executing the program stored in the ROM. The controller 41 may also be configured by hardware such as an application specific integrated circuit (ASIC) or a field programmable gate array (FPGA).

The discharge controller 42 controls the head 10 based on configuration information stored in the storage unit 45, and discharges the coating material from the plurality of discharge holes 11 toward the to-be-coated object 30. The operation controller 43 controls operations of the plurality of arms 21 based on the configuration information stored in the storage unit 45, and controls movement of the head 10 via the arms 21. The distance between the head 10 and the to-be-coated object 30 is maintained at, for example, approximately from 0.5 to 14 mm. Note that the detailed movement of the head 10 including the discharge of the coating material will be described later.

The storage unit 45 corresponds to, for example, the ROM and the HDD. The ROM and the HDD can store configuration information for various controls in the control device 40. The storage unit 45 stores information related to discharge control of the coating material by the head 10. Further, the storage unit 45 stores information related to the operation control of the plurality of arms 21. Note that the storage unit 45 may store data input by the user's instruction operation using a terminal apparatus (not illustrated) as instruction data for operating the robot 20. Further, the controller 41 may also acquire the configuration information via another computer or portable storage medium connected by a wired or wireless network.

The to-be-coated object 30 is, for example, a vehicle body. The to-be-coated object 30 is placed on a conveying device (not illustrated), and is carried in and out. The coating device 1 according to an embodiment coats the to-be-coated object 30 in a state where the conveying device is stopped. Note that the coating device 1 may coat the to-be-coated object 30 while the to-be-coated object 30 is being repeatedly conveyed and stopped, or may coat the to-be-coated object 30 while the to-be-coated object 30 is being conveyed.

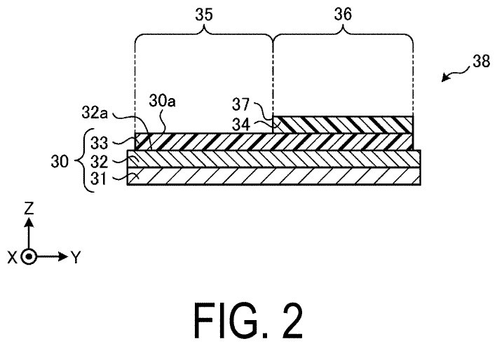

FIG. 2 is a cross-sectional view illustrating an example of a to-be-coated object that was coated. The to-be-coated object 30 illustrated in FIG. 2 includes a base member 31, a primer layer 32, and a first coating layer 33. The base member 31 is, for example, a steel plate processed into a predetermined shape, and is subjected to an electrodeposition process as necessary to impart rust resistance thereto. The primer layer 32 is provided for imparting weather resistance, color development, and peeling resistance, for example. The first coating layer 33 is, for example, a base layer that has smoothness and weather resistance and imparts a desired coating color. A surface of the first coating layer 33 serves as a to-be-coated surface 30a to be coated by the coating device 1 according to the embodiment.

A second coating layer 34 is located on the first coating layer 33 serving as the to-be-coated surface 30a. The second coating layer 34 is located so as to cover a portion of the first coating layer 33 with a coating material having a coating color different from that of the first coating layer 33. As a result, the to-be-coated object 30 becomes a coated body 38 that is coated in a so-called two tone color in which a region 36 where the second coating layer 34 is located and a region 35 where the first coating layer 33 is exposed without the second coating layer 34 being located are aligned with an end portion 37 of the second coating layer 34 as a boundary.

In the example illustrated in FIG. 2, the coating device 1 has been described such that the second coating layer 34 is located on the to-be-coated surface 30a on the first coating layer 33, but the present invention is not limited thereto, and the coating device 1 may be applied, for example, when the first coating layer 33 is located on a coated surface 32a on the primer layer 32.

Note that the coated body 38 is not limited to the example illustrated in FIG. 2. For example, a coating layer (not illustrated) may be located on the surfaces of the regions 35 and 36. Further, the second coating layer 34 need not be included, and only the first coating layer 33 may be included, and the second coating layer 34 may be located on the entire surface of the first coating layer 33. Further, the to-be-coated object 30 or the coated body 38 may further include one or a plurality of layers (not illustrated).

### First Embodiment

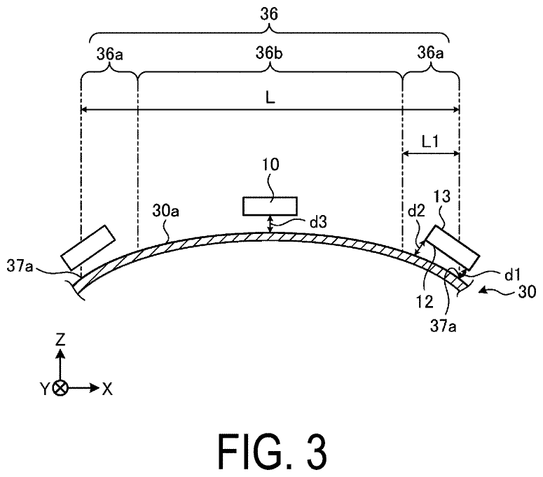

FIG. 3 is an explanatory view illustrating an example of an arrangement of a head included in a coating device according to a first embodiment. FIG. 3 corresponds to a cross-sectional view of the head 10 and the to-be-coated object 30 facing the nozzle surface 12 of the head 10 as viewed from a Y-axis negative direction side. Note that for ease of explanation, it is assumed that in the to-be-coated object 30, a center portion in an X-axis direction of the region 36 has an arch shape with a cross-sectional arc-shape protruding toward a Z-axis positive direction, and the to-be-coated surface 30a has a convex curved surface of the to-be-coated object 30. The to-be-coated object 30 is, for example, a hood, a roof, or a pillar of an exterior of the vehicle body. The to-be-coated object 30 may be, for example, an instrument panel, a glove box, or a center console of an interior of the vehicle body.

Further, in each of the embodiments described below, an example will be given of a case in which the head 10 discharges a coating material that positions the second coating layer 34 in the region 36. Further, the coating device 1 according to each embodiment described below has a common configuration, except for the movement of the head 10. As a result, other configurations, such as the robot 20 and the control device 40, except for the head 10, are omitted from the drawings.

The head 10 illustrated in FIG. 3 moves in a Y-axis direction serving as a first direction in a state of facing the to-be-coated object 30. The head 10 may achieve a surface area coating speed of, for example, 1 m²/min or more and 5 m²/min or less. In order to achieve such a surface area coating speed, assuming the length of the print region of the head 10 is 100 mm, the head 10 may be moved in the X-axis direction at a moving speed in the X-axis direction of a predetermined speed of, for example, 1.67×102 mm/s or more and 41.67×102 mm/s or less. Note that, in this example, one head 10 is used, but two or more heads 10 may be used.

The resolution of the head 10 can be, for example, 150 dots per inch (dpi) or more. More preferably, the resolution of the head 10 is 300 dpi or more. When the resolution of the head 10 is 150 dpi or more, the leveling property is improved and the quality of the coating film is improved. Note that the resolution of the head 10 need not necessarily be 150 dpi or more.

Further, in end portion regions 36a respectively located on end portion 37a sides of the region 36 serving as the coating region, the head 10 faces the to-be-coated surface 30a in an inclined posture so that a gap d1 between the nozzle surface 12 located on the end portion region 37a sides and the to-be-coated object 30 is smaller than a gap d2 between the nozzle surface 12 located on the center side of the region 36 and the to-be-coated object 30.

By positioning the head 10 to be inclined with respect to the to-be-coated surface 30a in this manner, a distance between the nozzle surface 12 and the end portion 37a of the region 36 is reduced. As a result, for example, a boundary of the second coating layer 34 that is to be located on the end portion 37a is sharp, and the appearance is improved. Thus, with the coating device 1 according to the present embodiment, the coating quality can be improved.

Here, the gap d1 can be, for example, approximately from 0.5 to 14 mm. Here, the gap d2 can be, for example, approximately from 2.0 to 30 mm. However, the gaps d1 and d2 can be changed in accordance with the size of the head 10 and the curvature of the to-be-coated surface 30a.

Further, in the center region 36b located between the end portion regions 36a of the region 36, a gap d3 between the nozzle surface 12 and the to-be-coated object 30 can be, for example, d1 or more and less than d2. By defining the gap d3 in this manner, the thickness of the second coating layer 34 is easily stabilized, and the coating quality can be improved.

Further, a length L1 along the X-axis direction of each of the end portion regions 36a can, with respect to a total length L along the X-axis direction of the region 36, be approximately length L1=0.1 L, for example, length L1=0.05 L or more and 0.15 L or less. Further, the end portion regions 36a are regions that are inclined more than the center region 36b. As a result, an interface between each of the end portion regions 36a and the center region 36b is less likely to be noticeable, and the coating quality can be improved. Further, a boundary between each of the end portion regions 36a and a non-coating region is clear, and the appearance is improved. In the present embodiment, the curvature of the to-be-coated surface 30a is illustrated as being larger in the end portion regions 36a than in the center region 36b, but the present invention is not limited thereto. For example, the curvature of the end portion regions 36a may be smaller than the curvature of the center region 36b, and the curvature may be constant over the entirety of the to-be-coated surface 30a.

### Second Embodiment

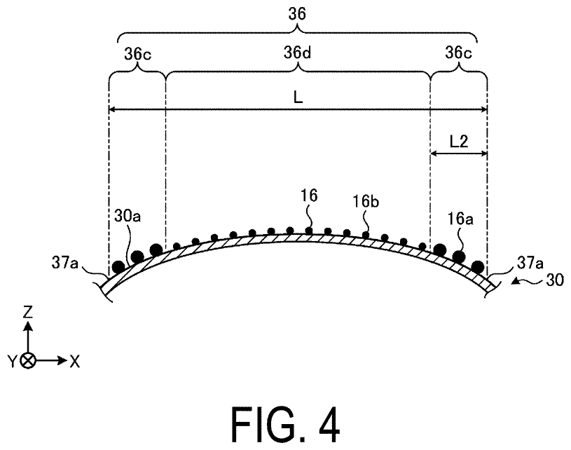

FIG. 4 is an explanatory view illustrating an example of discharge drops according to a second embodiment. As illustrated in FIG. 4, the size of the discharge drops formed by the coating material discharged from the nozzle surface 12 differs between the end portion regions 36a respectively located on the end portion 37a sides and a center region 36d located between the end portion regions 36c, of the region 36 serving as the coating region. Specifically, discharge drops 16a located in the end portion regions 36c are larger than discharge drops 16b located in the center region 36d.

By forming the discharge drops 16a to be larger than the discharge drops 16b in this manner, for example, the contrast of the second coating layer 34 that is to be located on the end portions 37a is enhanced and the appearance is improved. Thus, the coating quality can be improved.

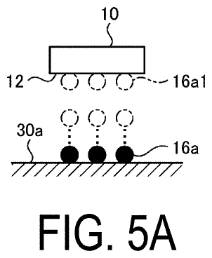

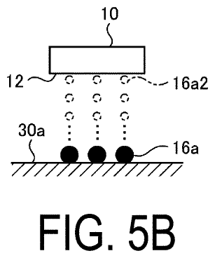

Here, a discharging technique of the coating material discharged onto the to-be-coated surface 30a of the end portion regions 36c will be described with reference to FIGS. 5A and 5B. FIGS. 5A and 5B are explanatory views comparing discharging techniques for discharging the coating material.

In the example illustrated in FIG. 5A, the discharge drops 16a having a size corresponding to the coating material 16a1 serving as a discharged liquid discharged from the nozzle surface 12 of the head 10 are located on the to-be-coated surface 30a. In other words, a discharge amount of the coating material 16a1 corresponds to the size of the discharge drops 16a. The head 10 illustrated in FIG. 5A is preferably prepared separately from the head 10 that discharges, for example, the discharge drops 16b. Thus, the coating device 1 according to the embodiment can include a plurality of the heads 10 in which the sizes of the discharge drops 16 are different.

On the other hand, the example illustrated in FIG. 5B differs from the example illustrated in FIG. 5A in that the size of a coating material 16a2 discharged from the nozzle surface 12 of the head 10 is smaller than the discharge drops 16a. By controlling a discharge gap of the coating material 16a2 and combining a plurality of the coating materials 16a2 until reaching the to-be-coated surface 30a, the discharge drops 16a larger than the coating material 16a2 can be located on the to-be-coated surface 30a. Thus, in the coating device 1 according to the embodiment, the discharge controller 42 controls the discharge gap from the nozzle surface 12, so that the amount of the coating material 16a2 serving as the discharged liquid discharged from the head 10 per unit surface area of the to-be-coated surface 30a can be changed. As a result, the end portion regions 36c and the center region 36d can be coated with one type of head 10.

Returning to FIG. 4, a length L2 along the X-axis direction of each of the end portion regions 36c can be approximately length L2=0.1 L, for example, length L2=0.05 L or more and 0.15 L or less with respect to the total length L along the X-axis direction of the region 36. Further, the end portion regions 36c are regions that are inclined more than the center region 36d. As a result, an interface between each of the end portion regions 36c and the center region 36d is less likely to be noticeable, and the coating quality can be improved. Further, a boundary between each of the end portion regions 36c and a non-coating region is clear, and the appearance is improved.

### Third Embodiment

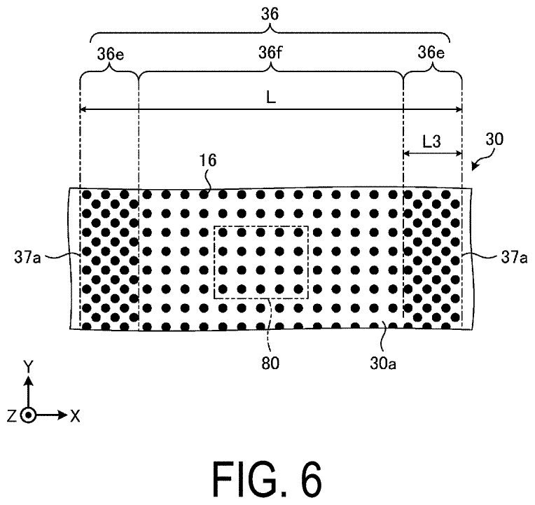

FIG. 6 is an explanatory view illustrating an example of discharge drops according to a third embodiment. As illustrated in FIG. 6, the discharge density of the coating material discharged from the nozzle surface 12 is different between end portion regions 36e respectively located on the end portion 37a sides and a center region 36f located between the end portion regions 36e, of the region 36 serving as the coating region. Specifically, the discharge density of the discharge drops 16 located in the end portion regions 36e is larger than the discharge density of the discharge drops 16 located in the center region 36f.

By making the discharge density of the discharge drops 16 located in the end portion regions 36e larger than the discharge density of the discharge drops 16 located in the center region 36f in this manner, for example, the contrast of the second coating layer 34 that is to be located on the end portions 37a is enhanced, and the appearance is improved. Thus, the coating quality can be improved.

Here, a length L3 along the X-axis direction of each of the end portion regions 36e can be approximately length L3=0.1 L, for example, length L3=0.05 L or more and 0.15 L or less with respect to the total length L along the X-axis direction of the region 36. Further, the end portion regions 36e are regions that are inclined more than the center region 36f. As a result, an interface between each of the end portion regions 36e and the center region 36f is less likely to be noticeable, and the coating quality can be improved. Further, a boundary between each of the end portion regions 36e and a non-coating region is clear, and the appearance is improved.

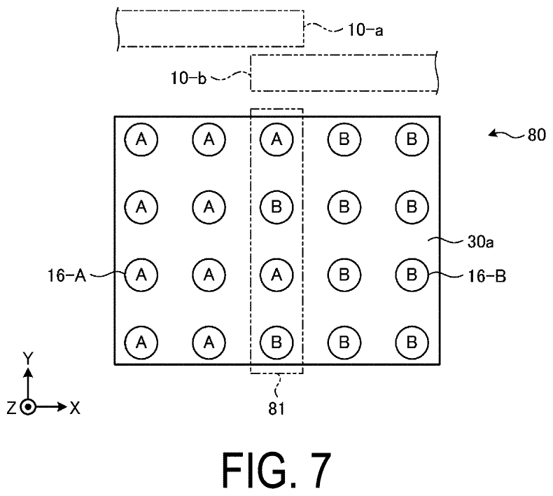

Further, as described above, the coating device 1 according to the embodiment moves the head 10 in the Y-axis direction serving as the first direction, subsequently displaces the head 10 in the X-axis direction in accordance with the dimension of the nozzle surface 12 in the X-axis direction, and moves the head 10 in the Y-axis direction again. This point will be described with reference to FIG. 7.

FIG. 7 is a partial enlarged view of FIG. 6. A region 80 illustrated in FIG. 7 corresponds to an enlarged view of the region 80 in the center region 36f illustrated in FIG. 6.

In FIG. 7, the discharge drops 16 discharged in the region 80 on the to-be-coated surface 30a by the head 10 located at a position 10-a in the X-axis direction moving in the Y-axis direction are schematically illustrated as discharge drops 16-A, and the discharge drops 16 discharged in the region 80 on the to-be-coated surface 30a from the head 10 located at a position 10-b are schematically illustrated as discharge drops 16-B.

In this case, in a portion 81, among the plurality of discharge holes 11 opening at the nozzle surface 12, discharge holes 11 located at an end portion on the X-axis positive direction side of the head 10 located at the position 10-A, and discharge holes 11 located at an end portion on the X-axis negative direction side of the head 10 located at the position 10-B overlap in plan view. By overlapping portions of the discharge holes 11 in plan view in this way, it is possible to reduce omission or blurring of coating, but there is a concern that uneven coating may occur.

Thus, as illustrated in FIG. 7, the discharge of the coating material from the nozzle surface 12 is controlled so that the discharge density in the portion 81 serving as the overlapping portion of the discharge holes 11 is smaller than the discharge density in a portion other than the portion 81. Accordingly, for example, the occurrence of coating unevenness in the portion 81 is reduced, and thus the coating quality can be improved. Note that in the example illustrated in FIG. 7, the discharge densities of the discharge drops 16-A and the discharge drops 16-B in the portion 81 are reduced to the same degree. but, the present invention is not limited thereto, and the discharge densities of the discharge drops 16-A and the discharge drops 16-B may be different from each other. Further, the discharge density in the portion 81 in each of the heads 10 may be less than the discharge density in the portion other than the portion 81, and for example, it is acceptable for the discharge density in the portion 81 to be 60% of the discharge density in the portion other than the portion 81 (in other words, the discharge density in the portion 81 is 120%).

### Fourth Embodiment

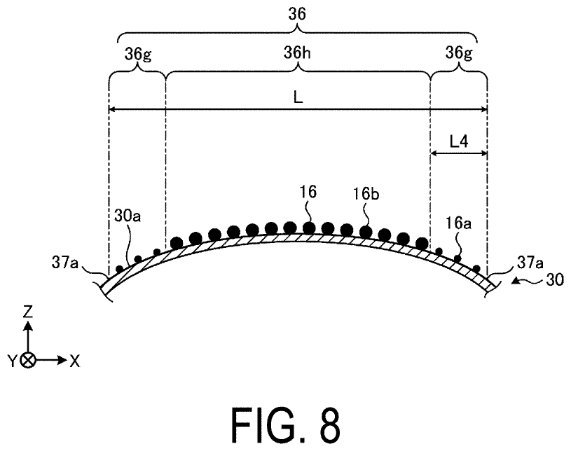

FIG. 8 is an explanatory view illustrating an example of discharge drops according to a fourth embodiment. As illustrated in FIG. 8, the fourth embodiment is similar to the third embodiment in that the size of the discharge drops formed by the coating material discharged from the nozzle surface 12 is different between end portion regions 36g respectively located on end portion 37a sides and a center region 36h located between the end portion regions 36g, of the region 36 serving as the coating region. In the present embodiment, discharge drops 16a located in the end portion regions 36g are smaller than discharge drops 16b located in the center region 36h.

By making the discharge drops 16a smaller than the discharge drops 16b in this manner, for example, the discharge drops 16b located on the end portions 37a having a curvature larger than the curvature of the center region 36h are less likely to drip, and the coating quality can be improved. Further, a boundary between each of the end portion regions 36g and a non-coating region is clear, and the appearance is improved.

Here, a length L4 along the X-axis direction of each of the end portion regions 36g can be approximately length L4=0.1 L, for example, length L4=0.05 L or more and 0.15 L or less with respect to the total length L along the X-axis direction of the region 36. Further, the end portion regions 36g are regions that are inclined more than the center region 36h. As a result, an interface between each of the end portion regions 36g and the center region 36h is less likely to be noticeable, and the coating quality can be improved. Further, a boundary between each of the end portion regions 36g and a non-coating region is clear, and the appearance is improved.

### Coating Film

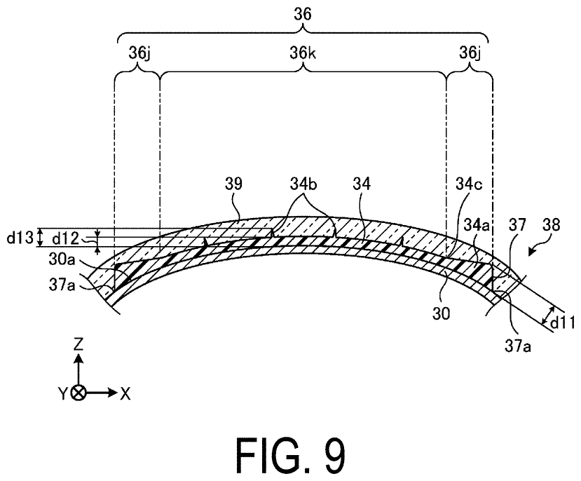

Next, a coating film according to an embodiment will be described. FIG. 9 is a cross-sectional view illustrating an example of a coated body according to the embodiment.

As illustrated in FIG. 9, the second coating layer 34 serving as a coating film includes a thick film portion 34a extending in the Y-axis direction serving as the first direction along the end portions 37a in end portion regions 36j respectively located on the end portion 37a sides, of the region 36 serving as the coating region. A thickness d11 of the thick film portion 34a is larger than a thickness d12 of the second coating layer 34 in a center region 36k located between the end portion regions 36j. As a result, for example, the contrast of the end portion 37 of the second coating layer 34 is enhanced and the appearance is improved. Thus, the coating quality can be improved.

Further, the second coating layer 34 includes a recessed portion 34c adjacent to the thick film portion 34a along the Y-axis direction. As a result, stress generated by the presence of the thick film portion 34a can be alleviated, and peeling of the second coating layer 34 from the to-be-coated surface 30a is reduced. Note that the recessed portion 34c refers to an inflection point at which the thick film portion 34a and the center region 36k intersect with each other in a cross-sectional view, and need not have a thickness smaller than the thickness d12 of the second coating layer 34.

Here, the thickness d11 can be, for example, approximately from 7 μm to 70 μm. Further, the thickness d12 can be, for example, from approximately 5 μm to approximately 50 μm.

Further, the second coating layer 34 includes a plurality of convex portions 34b located along the Y-axis direction in the center region 36k serving as the center portion of the coating region. When the thickness d12 of the second coating layer 34 in the convex portion 34b is smaller than the thickness d11 of the thick film portion 34a, for example, the occurrence of the coating unevenness in the convex portion 34b is reduced, and thus the coating quality can be improved. On the other hand, when the thickness d12 of the second coating layer 34 in the convex portion 34b is larger than the thickness d11 of the thick film portion 34a, for example, the contrast of the end portion 37 is enhanced and the appearance is improved. Thus, the coating quality can be improved. Note that in the coated body 38 in which a covering layer 39 is located on the second coating layer 34, for example, color unevenness originating from the protrusion 34b is less likely to be noticeable, and the coating quality is further improved.

### Variation of First Embodiment

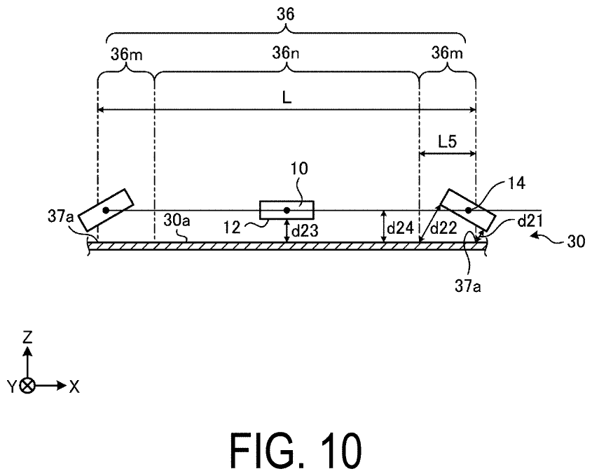

In each embodiment described above, the to-be-coated object 30 is described as having the arch shaped curved surface, but the present invention is not limited thereto, and may have, for example, a dome-shaped curved surface. Further, the to-be-coated surface 30a of the to-be-coated object 30 may be a flat surface or may be produced by a drawing process. FIG. 10 is an explanatory view illustrating an arrangement of a head according to a variation of the first embodiment.

In the to-be-coated object 30 illustrated in FIG. 10, the to-be-coated surface 30a is the flat surface, which is different from the to-be-coated surface 30a coated by the coating device 1 according to the first embodiment.

Further, in end portion regions 36m respectively located on the end portion 37a sides of the region 36 serving as the coating region, the head 10 faces the to-be-coated surface 30a in an inclined posture so that a gap d21 between the nozzle surface 12 located on the end portion region 37a sides and the to-be-coated object 30 is smaller than a gap d22 between the nozzle surface 12 located on the center side of the region 36 and the to-be-coated object 30.

By locating the head 10 so as to be inclined with respect to the to-be-coated surface 30a in this manner, a distance between the nozzle surface 12 and the end portion 37a is reduced. As a result, for example, a boundary of the second coating layer 34 that is to be located on the end portion 37a is sharp, and the appearance is improved. Thus, the coating quality can be improved.

Here, the gap d21 can be, for example, approximately from 0.5 to 20 mm. Here, the gap d22 can be, for example, approximately from 2 to 30 mm.

Further, in a center region 36n located between the end portion regions 36m of the region 36, a gap d23 between the nozzle surface 12 and the to-be-coated object 30 can be, for example, d21 or more and less than d22. By defining the gap d23 in this manner, the thickness of the second coating layer 34 is easily stabilized, and the coating quality can be improved. Note that in the example illustrated in FIG. 10, the gap 24 between a center 14 of the head 10 and the to-be-coated surface 30a is always constant over the entire region 36. As a result, the thickness of the second coating layer 34 is further easily stabilized, and the coating quality can be improved.

Further, a length L5 along the X-axis direction of each of the end portion regions 36m can be approximately length L5=0.1 L, for example, length L5=0.05 L or more and 0.15 L or less with respect to the total length L along the X-axis direction of the region 36.

Each embodiment according to the present invention was described above. However, the present invention is not limited to the embodiments described above, and various modifications can be made without departing from the essential spirit of the present invention. For example, in the embodiments described above, the coating device 1 including the head 10 configured to discharge a single color coating material was described. However, for example, robots 20 respectively holding heads 10 for discharging coating materials of basic colors such as magenta (M), yellow (Y), cyan (C), and black (K) may be included.

Furthermore, in the embodiments described above, examples have been illustrated in which coating is performed on the to-be-coated surface 30a from the Z-axis positive direction side, but the present invention is not limited thereto, and for example, coating may be performed from the Z-axis negative direction side, and a side surface located along a YZ plane or a ZX plane may serve as the to-be-coated surface 30a. Further, the coating device 1 may be applied in a case where the to-be-coated surface 30a located obliquely with respect to the Z axis is coated.

Two or more of the first to fourth embodiments may also be combined. In this case, the lengths L1 to L4 may be the same as or different from each other.

As described above, the coating device 1 according to the embodiments coats the to-be-coated object 30 having the convex curved surface. The coating device 1 includes the head 10, the arm 21, and the controller 41. The head 10 includes the nozzle surface 12. The arm 21 holds the head 10. The controller 41 controls the movement of the head 10 via the arm 21. The controller 41 moves the head 10 in the first direction along the end portions 37a of the coating region in the state where the head 10 is located so that the gap d1 between the nozzle surface 12 located on the end portion 37a sides of the coating region of the to-be-coated object 30 and the to-be-coated object 30 is smaller than the gap d2 between the nozzle surface 12 located on the center side of the coating region and the to-be-coated object 30. Thus, the coating quality can be improved.

Further, the coating device 1 according to the embodiments coats the to-be-coated object 30 having the convex curved surface. The coating device 1 includes the head 10, the arm 21, and the controller 41. The head 10 includes the nozzle surface 12. The arm 21 holds the head 10. The controller 41 controls the movement of the head 10 via the arm 21. The head 10 discharges the coating material as discharge drops of different sizes between the end portions of the coating region and the center portion of the coating region. Thus, the coating quality can be improved.

Further, the coating device 1 according to the embodiments coats the to-be-coated object 30 having the convex curved surface. The coating device 1 includes the head 10 and the controller 41. The head 10 includes the nozzle surface 12. The controller 41 controls the discharge of the coating material from the nozzle surface 12. The discharge density of the coating material in the end portion of the coating region of the to-be-coated object 30 is larger than the discharge density in the center portion of the coating region. Thus, the coating quality can be improved.

Further, the coating film according to the embodiments includes the thick film portion 34a extending in the first direction along the end portion of the coating region of the to-be-coated object 30. Thus, the coating quality can be improved.

Additional effects and variations can be easily derived by a person skilled in the art. Thus, a wide variety of aspects of the present invention are not limited to the specific details and representative embodiments represented and described above. Accordingly, various changes are possible without departing from the spirit or scope of the general inventive concepts defined by the appended claims and their equivalents.

### REFERENCE SIGNS LIST

1 Coating device
10 Head
11 Discharge hole
12 Nozzle surface
16 Discharge drop
20 Robot
21 Arm
30 To-be-coated object
30a To-be-coated surface
40 Control device
41 Controller
42 Discharge controller
43 Operation controller
45 Storage unit

1. A coating device configured to coat a coating region of a to-be-coated object having a convex curved surface, the coating device comprising:
a head comprising a nozzle surface;
an arm configured to hold the head; and
a controller configured to control movement of the head via the arm,
wherein the controller is configured to move the head in a first direction along an end portion of the coating region in a posture in which a gap between the nozzle surface and the to-be-coated object at an end portion side of the coating region is smaller than a gap between the nozzle surface and the to-be-coated object at a center side of the coating region.

2. A coating device configured to coat a coating region of a to-be-coated object having a convex curved surface, the coating device comprising:
a head comprising a nozzle surface;
an arm configured to hold the head; and
a controller configured to control discharge of a coating material from the nozzle surface,
wherein the head is configured to discharge the coating material as discharge drops of different sizes between an end portion of the coating region and a center portion of the coating region.

3. The coating device according to claim 2, wherein
a discharge drop, of the discharge drops, discharged in the center portion is smaller than a discharge drop, of the discharge drops, discharged in the end portion.

4. The coating device according to claim 2, wherein
a discharge drop, of the discharge drops, discharged in the end portion is smaller than a discharge drop, of the discharge drops, discharged in the center portion.

5. The coating device according to claim 2, wherein
the head comprises a plurality of heads in which the discharge drops have different sizes.

6. (canceled)

7. A coating device configured to coat a coating region of a to-be-coated object having a convex curved surface, the coating device comprising:
a head comprising a nozzle surface; and
a controller configured to control discharge of a coating material from the nozzle surface,
wherein a discharge density of the coating material in an end portion of the coating region is larger than the discharge density of the coating material in a center portion of the coating region.

8. The coating device according to claim 7, further comprising:
an arm configured to hold the head and operate the head based on control of the controller, wherein
the head comprises a plurality of discharge holes opening at the nozzle surface partially overlapping each other in a plan view, and
the controller is configured to move the head such that the discharge density of the coating material from an overlapping portion of the plurality of discharge holes is smaller than the discharge density of the coating material from a portion of the plurality of discharge holds other than the overlapping portion.

9. The coating device according to claim 1, wherein
a resolution of the head is 150 dpi or more.

10-15. (canceled)
